(19) United States
(12) Patent Application Publication
(10) Pub. No.: US 2006/0095421 A1
(43) Pub. Date: May 4, 2006

(54) Method, apparatus, and program for searching for data

(75) Inventors: Hiroyuki Nagai, Inagi-shi (JP); Daisuke Tanaka, Meguro-ku (JP); Fumiaki Itoh, Yokohama-shi (JP)

Correspondence Address: Canon U.S.A. Inc.,;Intellectual Property Division, 15975 Alton Parkway, Irvine, CA, 92618-3731, US

(73) Assignee: Canon Kabushiki Kaisha, Ohta-ku (JP)

(21) Appl. No.: 11/253,331

(22) Filed: Oct. 19, 2005

(30) Foreign Application Priority Data
Oct. 22, 2004 (JP) 2004-308331
Jul. 22, 2005 (JP) 2005-212919

(51) Int. Cl. G06F 17/30

(52) U.S. Cl. 707/3

(57) ABSTRACT

A data-search apparatus, method and program are provided which are adapted to search for a plurality of pieces of data, each piece having version data indicating that the piece is derived from certain data. The method includes calculating scores of search results of pieces of data in data groups, each data group being derived from the same data, on the basis of the version data, and determining the order of the search results on the basis of the scores.

### BACKGROUND OF THE INVENTION

1. Field of the Invention

The present invention relates to a method, an apparatus, and a program for searching data correlated to document versions derived from certain data.

2. Description of the Related Art

A document search engine for searching for documents, wherein each has a plurality of versions, is typically a data search peculiar to a document control apparatus. An example of a data search that includes a version control function which controls document updates is disclosed in Japanese Patent Laid-Open No. 9-128380.

### SUMMARY OF THE INVENTION

The present invention provides a data-search apparatus, a data-search method, and a program for determining the order of search results with consideration of version data indicating that corresponding data is derived from certain data.

According to one aspect of the present invention, a data-search method is provided that searches for a plurality of pieces of data, each piece having version data indicating that the piece is derived from certain data. The data-search method includes calculating scores of search results of pieces of data in data groups, each data group being derived from the same data, on the basis of the version data, and determining the order of the search results on the basis of the scores.

According to another aspect of the present invention, a data-search apparatus searches for a plurality of pieces of data, each piece having version data indicating that the piece is derived from certain data. The data-search apparatus includes a calculating unit that calculates scores of search results of pieces of data in data groups, each data group being derived from the same data, on the basis of the version data, and an order-determining unit that determines the order of the search results on the basis of the scores.

According to still yet another aspect of the present invention, a program is provided which performs a data-search process adapted to search for a plurality of pieces of data, each piece having version data indicating that the piece is derived from certain data. The data-search process calculates scores of search results of pieces of data in data groups, each data group being derived from the same data, on the basis of the version data, and determines the order of the search results on the basis of the scores.

Further features and aspects of the present invention will become apparent from the following description of numerous exemplary embodiments with reference to the attached drawings.

### BRIEF DESCRIPTION OF THE DRAWINGS

FIG. 1 is a block diagram of a data-search apparatus, according to a first exemplary embodiment of the present invention.

FIG. 2A is a view showing exemplary document data and version data retained by a document-data control unit, according to an aspect of the present invention.

FIG. 2B is a view of an exemplary document control system, according to the first embodiment of the present invention.

FIG. 2C is a view showing exemplary folder-version control data retained by the document-data control unit, according to an aspect of the present invention.

FIG. 3 is a view showing exemplary document content, according to an aspect of the present invention.

FIG. 4 is a view showing more exemplary document content, according to an aspect of the present invention.

FIG. 5 is a view showing still yet more exemplary document content, according to an aspect of the present invention.

FIG. 6 is a view showing an exemplary interface screen for data search, according to an aspect of the present invention.

FIG. 7 is a view showing exemplary output data from a document-data search unit, according to an aspect of the present invention.

FIG. 8 is a view showing exemplary output data from a search-result integration unit, according to an aspect of the present invention.

FIG. 9 is a view showing exemplary version scores calculated by a ranking unit, according to an aspect of the present invention.

FIG. 10 is a view showing exemplary document scores calculated by the ranking unit, according to an aspect of the present invention.

FIG. 11 shows an exemplary search-result screen for a case where a list of matched versions of documents is presented as a search result, according to an aspect of the present invention.

FIG. 12 shows an exemplary search-result screen for a case where a list of documents is presented as search results, according to an aspect of the present invention.

FIG. 13 is a view showing exemplary document data and version data retained by the document-data control unit, according to an aspect of the present invention.

FIG. 14 shows exemplary output data from the document-data search unit, according to an aspect of the present invention.

FIG. 15 is a view showing version scores calculated by the ranking unit, according to an aspect of the present invention.

FIG. 16 is a view showing exemplary document scores calculated by the ranking unit, according to an aspect of the present invention.

FIG. 17 shows an exemplary computer configured to execute software that performs various functions, according to an aspect of the present invention.

### DESCRIPTION OF THE EMBODIMENTS

### FIRST EXEMPLARY EMBODIMENT

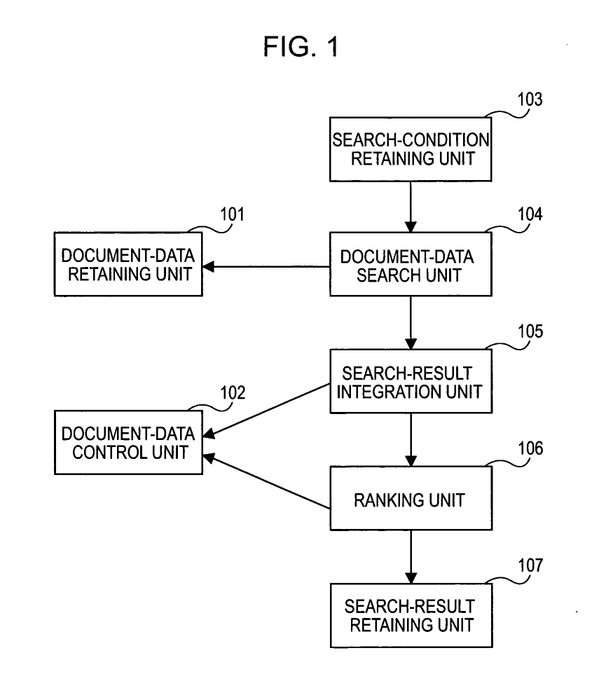

A first exemplary embodiment according to the present invention will now be described with reference to FIGS. 1 to 12.

The first embodiment can be applied to a data search in a document control apparatus in a case where most of user-desired data falls under a specific category, for example, a data search in a knowledge base. Document data in this embodiment may include, but is not limited thereto, data of documents, still images, moving images, voices, and the like.

FIG. 1 is a block diagram showing an overall architecture of an exemplary data-search apparatus, according to an embodiment of the present invention. The data-search apparatus includes a document-data retaining unit 101 that retains multiple versions of documents, a document-data control unit 102 that controls versions of individual documents and associated document data, a search-condition retaining unit 103 that retains search conditions, a document-data search unit 104 that searches for document data that satisfies the search conditions, a search-result integration unit 105 that integrates the search results on the basis of matched document data and version data, a ranking unit 106 that determines the order of presenting the matched documents and the versions, and a search-result retaining unit 107 that retains the search results.

The document-data retaining unit 101 retains document data of individual versions of documents. The document-data control unit 102 retains control data related to the individual document data and associated versions of documents.

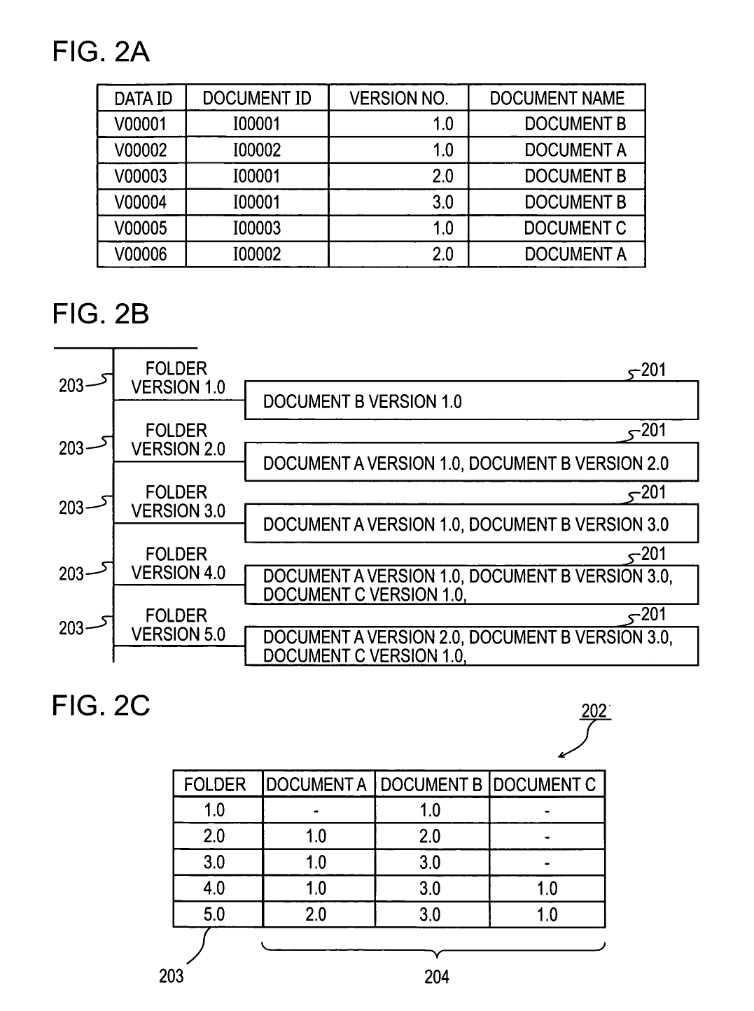

When a new document or a new version of a document is registered in a document control apparatus, an ID is assigned to the new document or the new version of the document, and this document is retained as document data by the document-data retaining unit 101. A document data ID, a document ID, a version number, and a document name, and the linkages among these data are retained by the document-data control unit 102 so that the document data and an associated version of the document can be identified. The content of the retained data is shown in FIG. 2A.

In FIG. 2A, a document A (document ID: I00002), a document B (document ID: I00001), and a document C (document ID: I00003) are registered. Versions 1.0 (document data ID: V00002) and 2.0 (document data ID: V00006) are registered for the document A, versions 1.0 (document data ID: V00001), 2.0 (document data ID: V00003), and 3.0 (document data ID: V00004) are registered for the document B, and version 1.0 (document data ID: V00005) is registered for the document C.

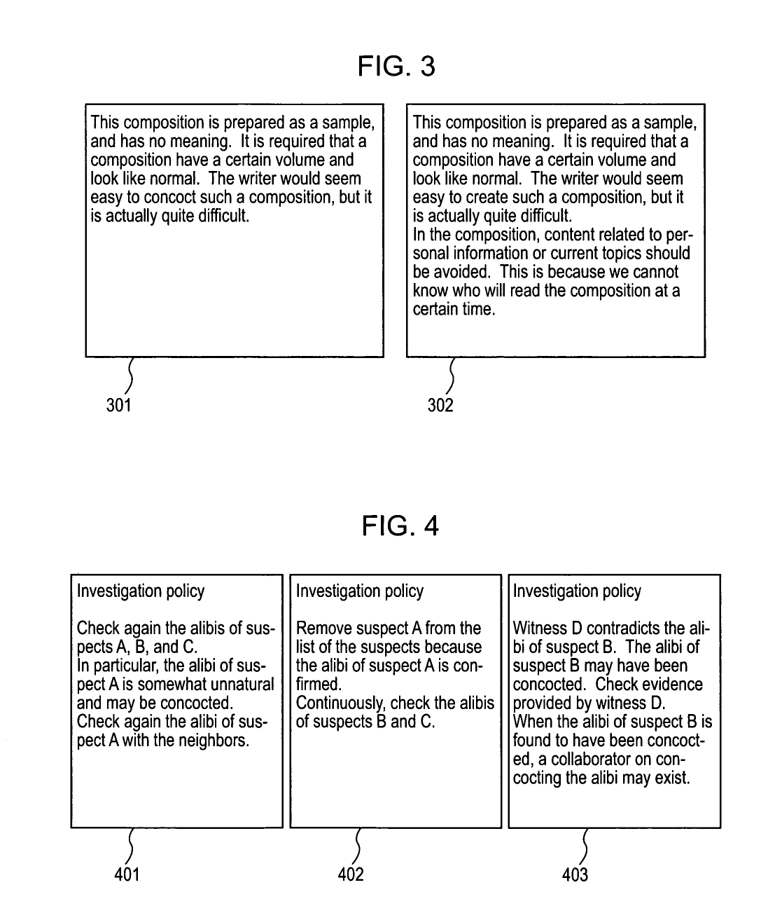

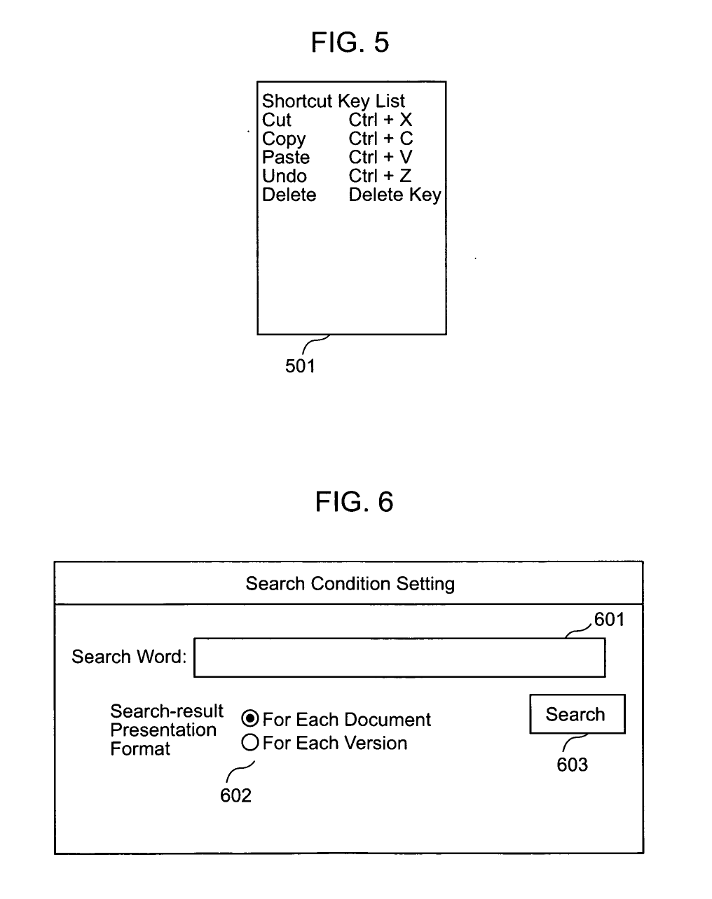

FIG. 3 shows exemplary content of the two versions of the document A. Document data 301 (document data ID: V00002, version: 1.0) is updated and registered as document data 302 (document data ID: V00006, version: 2.0). Document data 401, 402, and 403 in FIG. 4 and document data 501 in FIG. 5 correspond to versions 1.0 to 3.0 of the document B and version 1.0 of the document C, respectively.

In this embodiment, a version number starts from 1.0 and is increased by one every time a document is updated. Alternatively, other numbering systems may be used so long as updates of document data can be traced. Besides a method for assigning a number to a file name or metadata of a document as version data, a method for assigning the time, date, time interval, or the like, at which a document is updated, as version data may be also further be adopted.

In version control in a document control apparatus, a general method is used similar to that used in a concurrent versions system (CVS). In this method for version control, when a document is updated, a user declares to the document control apparatus in advance that the document is to be updated (check-out). Subsequently, the updated document is registered in the document control apparatus (check-in).

FIG. 2B is a schematic view of an exemplary control system for storing multiple versions of documents. A folder 201 stores individual documents, and a folder version 203 is assigned to the folder 201. The folder version 203 is updated when a document included in the folder 201 is updated. As shown in FIG. 2C, the document-data control unit 102 may control the folder version 203 and associated document versions 204 of documents included in the folder 201 in folder-version control data 202.

The search-condition retaining unit 103 retains search conditions sent from the user to the data-search apparatus and passes the search conditions to the document-data search unit 104. FIG. 6 is a view showing an exemplary user interface for the user to send a query to the data-search apparatus. The user specifies search conditions in a text box 601 and with use of option buttons 602. In the text box 601, the user inputs search words. With the option buttons 602, the user specifies a presentation format of search results. The presentation format will be described below. After the user specifies search conditions, the user submits a query to the data-search apparatus by pressing a command button 603.

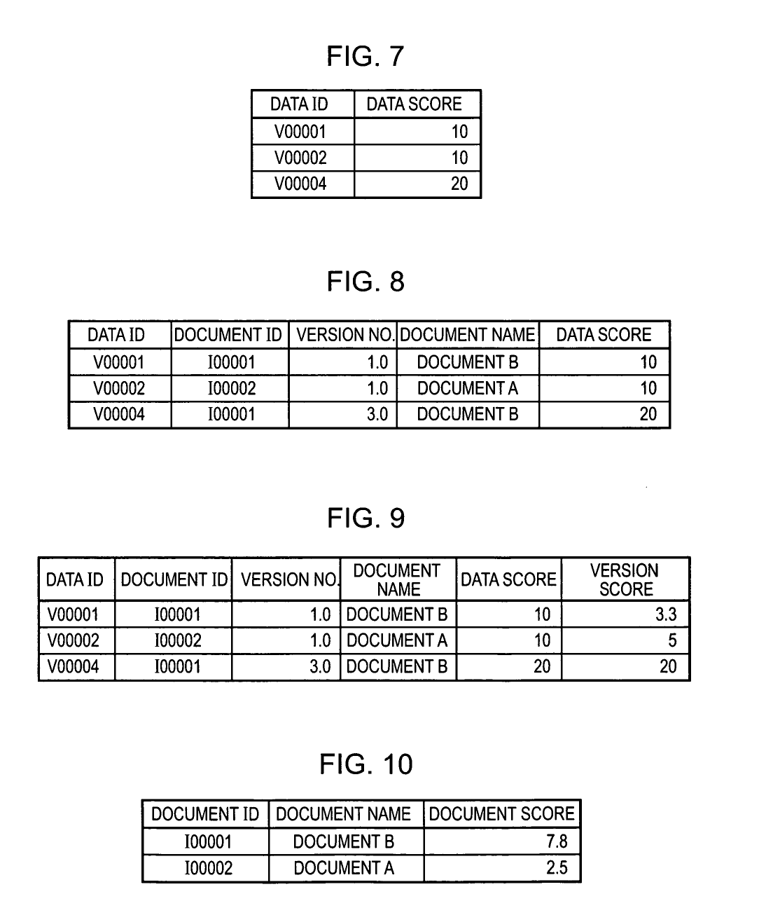

The document-data search unit 104 searches for data under the search conditions retained by the search-condition retaining unit 103. A general method for a full-text search is used to search for data. Additionally, a pattern-matching method or an index search method in which indices are generated in advance when data is registered may also be used. In the index search method, the document-data control unit 102 also controls indices. As results of the query, IDs of individual document data that includes the search words and match rates (data scores) of the individual document data with the search conditions are obtained. The data score of each document data is obtained on the basis of the frequency of occurrence and occurrence positions in the document of the search words, and the like. FIG. 7 shows exemplary results of a data search with a search word “concoct”. Three documents having document data IDs V00001, V00002, and V00004 match the search word, and data scores of these documents are obtained, the aforementioned example.

The search-result integration unit 105 obtains document IDs and version numbers of the matched document data from the table retained by the document-data control unit 102 on the basis of document data IDs of the matched document data obtained by the document-data search unit 104. For the case described above, the obtained data is shown in FIG. 8. The matched documents are the document A having a version number 1.0 and the documents B having version numbers 1.0 and 3.0.

The ranking unit 106 calculates version scores of the matched documents with consideration of the versions and gives ranks to the matched documents to determine the order of presenting the matched documents and the versions obtained by the search-result integration unit 105.

An exemplary process for calculating version scores of matched documents and ranking the matched documents will now be described. In this process, the newer the version of a matched document is, the higher the score is. This is because a defined user requirement is to give a higher priority to newer data. An exemplary version score is given by the following equation:
Version score=(data score)×(version number)+(latest version number)
For example, the version score of the document B having a version number 1.0 is given by
10×1.0÷3.0≅3.3.
Version scores calculated in this way are shown in FIG. 9. It is also acknowledged that the process for calculating version scores of matched documents described above may take another form, and therefore, should not be limited only to the example shown above.

Then, the search results are arranged according to the presentation format of the search results, which is one of the search conditions. The presentation format of the search results may be a list of matched versions of documents, or a list of documents including matched versions without version information. In the case of the list of documents, the user can gain an overall understanding of the search results and need not check individual versions of documents having similar content. In the case of the list of matched versions of documents, the user can gain detailed data about individual documents.

When the list of documents is presented as the search results, a document score of each document is calculated to integrate version scores of all the versions of each document. The document score is given by the following equation:
Document score=(Σversion scores)÷(the total number of versions of a document)
For example, the document score of the document B is given by
(3.3+20)÷3≈7.8.
Document scores calculated in this way are shown in FIG. 10. When the list of matched versions of documents is presented as the search results, no calculation is performed for presentation.

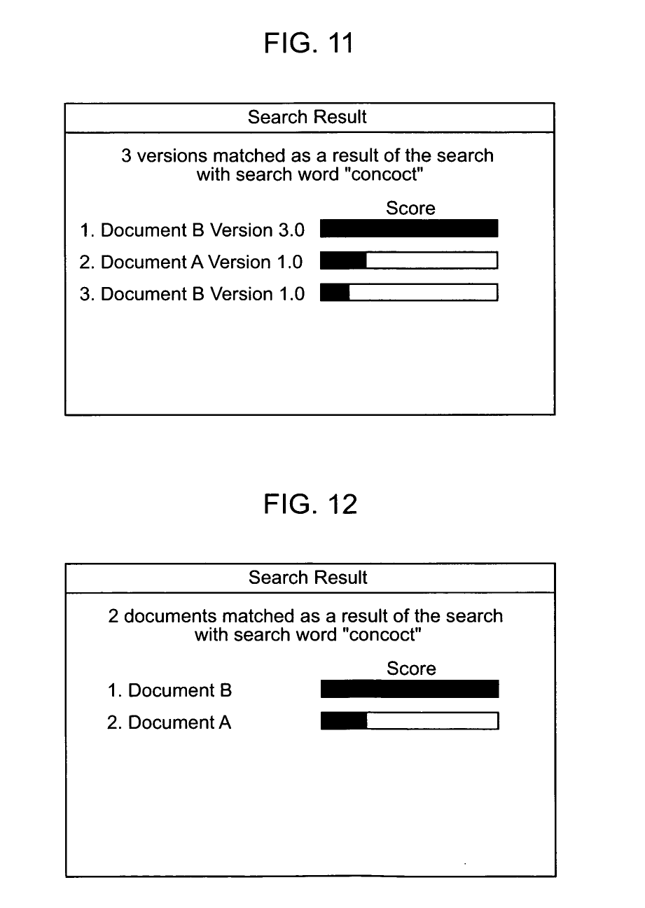

The search-result retaining unit 107 generates a search-result screen on the basis of the scores passed from the ranking unit 106. FIG. 11 shows an exemplary search-result screen for the case where the list of matched versions of documents is presented as the search results, and FIG. 12 shows an exemplary search-result screen for the case where the list of documents is presented as the search results.

### SECOND EXEMPLARY EMBODIMENT

In the first embodiment, when the ranking unit 106 calculates scores, a weighted calculation is performed so that a newer version of a document has a higher score than an older version to give a higher priority to newer data. On the other hand, in a second embodiment, a weighted calculation is performed depending on a presentation format of search results.

In particular, when a list of matched versions of documents is presented as the search results, a weighted calculation is performed so that a matched version of a document having a previous or next version that does not match search conditions has a higher score. This applies to a case where version 2.0 of a document matches the search conditions while versions 1.0 and 3.0 of the document do not match the search conditions. This is because more weight is placed on a version including the search words that do not exist in a previous or next version.

On the other hand, when a list of documents is presented as the search results, a weighted calculation is performed so that a document having more versions that match the search conditions has a higher score. This is because more weight is placed on a document always having a description that includes the search words.

Specifically, the process performed in the ranking unit 106 in the second embodiment is different from that in the first embodiment. In particular, the process performed in the ranking unit 106 branches off depending on a presentation format of the search results.

When a list of matched versions of documents is presented as the search results, the version score of a matched version of a document having no previous or next matched version is calculated with an added weight on the data score of this version. When the previous version of a matched version of a document is not included in the search results or the matched version is the oldest one, the data score of this version is multiplied by 1.5. Similarly, when the next version of the matched version of a document is not included in the search results or the matched version is the latest one, the data score of this version is multiplied by 1.5.

For example, when the previous and next versions of the matched version of a document are not included in the search results, the version score of the matched version is 2.25 (=1.5×1.5) times as much as the data score. In contrast, when the previous and next versions of the matched version of a document are included in the search results, the version score of the matched version is equal to the data score.

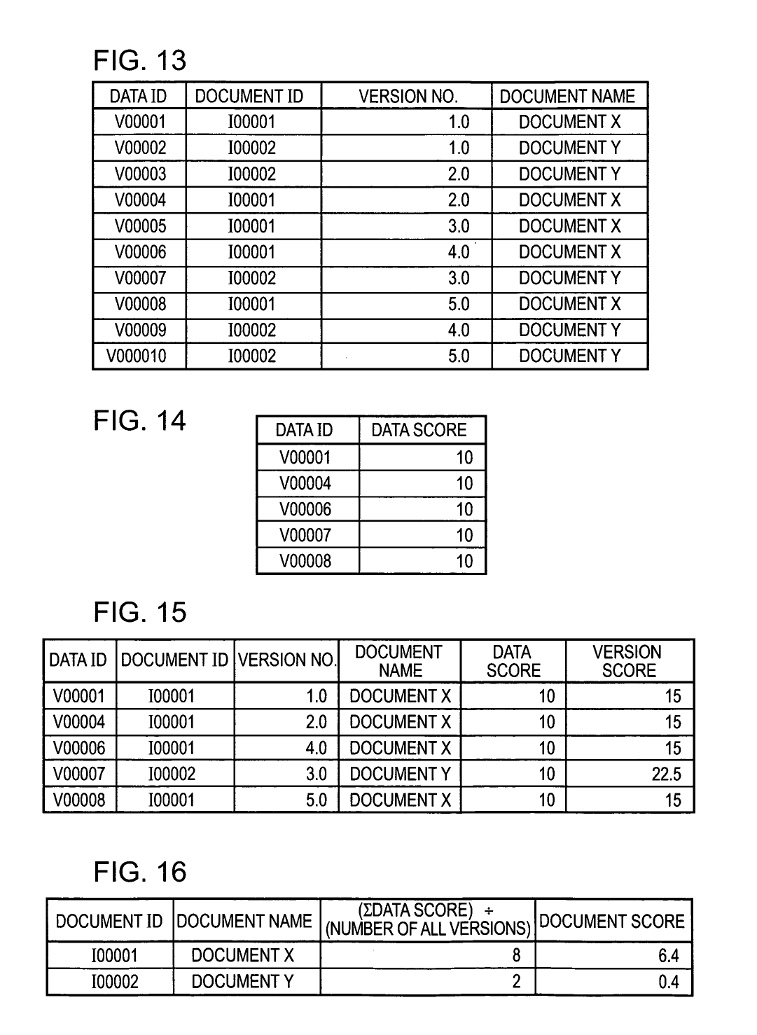

When two documents X and Y, each having five versions, are registered as shown in FIG. 13 and search results obtained by the document-data search unit 104 are as shown in FIG. 14, version scores of matched versions of the documents are produced as shown in FIG. 15. In FIG. 15, the version score of version 3.0 of the document Y, which is the only version that matches search conditions among versions of the document Y, is high.

On the other hand, when a list of documents is presented as search results, the document score of a document having more matched versions is calculated with a higher added weight on this document. Specifically, the total of data scores of matched versions of each document is divided by the total number of versions of the document, and then this calculation result is multiplied by the number of matched versions of the document and then divided by the total number of versions of the document to obtain the document score of the document. Document scores based on the data scores shown in FIG. 14 are shown in FIG. 16. Here, the document score of the document X having many matched versions is high.

### THIRD EXEMPLARY EMBODIMENT

In the embodiments described above, the components of the data-search apparatus are included in a single computer. Alternatively, the components may be included in a plurality of computers.

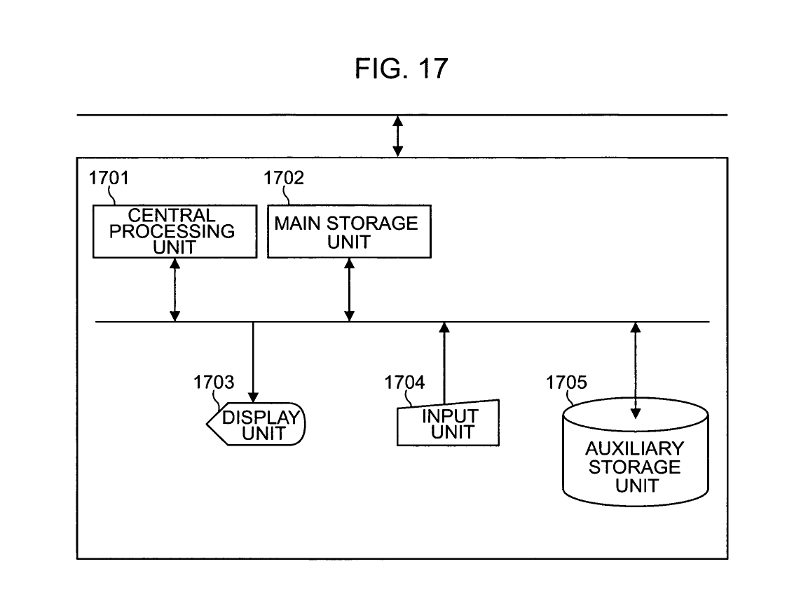

Furthermore, the present invention may be applied to a system including a plurality of units, or may be applied to a device including a single unit. It is apparent that the present invention may also be implemented by providing to a system or a device, a recording medium storing program codes of software that perform the functions according to the embodiments described above, and by causing a computer (a CPU or an MPU) included in the system or in the device, to read out and execute the program codes stored in the recording medium. For example, the present invention can be implemented by an exemplary general computer shown in FIG. 17. This computer includes a central processing unit 1701, a main storage unit 1702, a display unit 1703, an input unit 1704, and an auxiliary storage unit 1705.

In this case, the program codes read from the recording medium perform the functions according to the embodiments described above, and thus, the present invention may include the recording medium storing the program codes.

Typical recording media for providing the program codes are, but are not limited thereto, floppy disks, hard disks, optical disks, CD-ROMs, CD-Rs, DVD-ROMs, magnetic tapes, nonvolatile memory cards, ROMs or the like.

Moreover, other than the case where the program codes are read out and executed by a computer to perform the functions according to the embodiments described above, it is apparent that the present invention may also include a case where, for example, an operating system (OS) operating on a computer executes some or all of the actual processing to perform the functions according to the embodiments described above, based on instructions from the program codes.

Moreover, it is apparent that the present invention may also include a case where the program codes read out from the recording medium are written to a memory included in, for example, a function expansion board inserted in a computer or a function expansion unit connected to a computer, and then, for example, a CPU included in the function expansion board, the function expansion unit, or the like executes some or all of the actual processing to perform the functions according to the embodiments described above, based on instructions from the program codes.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2004-308331 filed Oct. 22, 2004 and No. 2005-212919 filed Jul. 22, 2005, which are hereby incorporated by reference herein in their entirety.

What is claimed is:

1. A data-search method for searching for a plurality of pieces of data, each piece having version data indicating that the piece is derived from certain data, the data-search method comprising:
calculating scores of search results of pieces of data in data groups on the basis of the version data, wherein each data group is derived from the same data; and
determining the order of the search results on the basis of the scores.

2. The method according to claim 1, wherein the scores of the search results of the pieces of data in the data groups are calculated on the basis of a chronological order of versions of the pieces of data, the versions matching a search condition.

3. The method according to claim 1, wherein the scores of the search results of the pieces of data in each data group are integrated to determine the order of the data groups.

4. A data-search apparatus for searching for a plurality of pieces of data, each piece having version data indicating that the piece is derived from certain data, the data-search apparatus comprising:
a calculating unit adapted to calculate scores of search results of pieces of data in data groups on the basis of the version data, wherein each data group is derived from the same data; and
an order-determining unit adapted to determine the order of the search results on the basis of the scores.

5. A computer readable medium that describes a data-search process for searching for a plurality of pieces of data, each piece having version data indicating that the piece is derived from certain data, wherein the medium causes a computer to execute the data-search process, the computer readable medium comprising:
computer-executable instructions for calculating scores of search results of pieces of data in data groups, each data group being derived from the same data, on the basis of the version data; and
computer-executable instructions for determining the order of the search results on the basis of the scores.
